(19) United States
(12) Patent Application Publication
(10) Pub. No.: US 2012/0236606 A1
(43) Pub. Date: Sep. 20, 2012

(54) METHOD AND SYSTEM FOR APPLYING POWER HARMONICS TO SECONDARY LOADS

(76) Inventor: George Albert Mazzoli, Garnet Valley, PA (US)

(21) Appl. No.: 13/422,617

(22) Filed: Mar. 16, 2012

Related U.S. Application Data
(60) Provisional application No. 61/454,086, filed on Mar. 18, 2011.
(60) Provisional application No. 61/592,956, filed on Jan. 31, 2012.

(51) Int. Cl. H02M 1/12

(52) U.S. Cl. 363/39

(57) ABSTRACT

A system and method for harvesting and applying power harmonics (e.g., harmonic distortion) comprises a shunt filter that is harmonically tuned for one or more connected loads. The shunt filter generally comprises at least one inductor connected serially to at least one capacitor. Additionally, the output leg of the capacitor (i.e., not connected to the inductor) is connected to at least one load. Operatively, the shunt filter separates harmonic current and, in some instances, the fundamental current from the root mean square current originating from a power source delivering power to the one or more connected loads. Illustratively, the harmonic current is directed to the one or more connected loads. The neutral current originating from the one or more filter connected loads is then returned back to the power source.

### CROSS-REFERENCE TO RELATED APPLICATIONS

This application claims the benefit of U.S. Provisional Application No. 61/454,086, filed Mar. 18, 2011, and U.S. Provisional Application No. 61/592,956, filed Jan. 31, 2012, the entire contents of which are incorporated herein by reference as if fully set forth.

### BACKGROUND

In most modern power applications, a power source is used to provide power to a load. Frequently, the current and voltage wave forms generated by the power source suffer from harmonic distortion which lowers the quality of power provided to a load, causing the load to draw power inefficiently (e.g., the harmonic distortion generally being expressed as heat in a connected load). Harmonic distortion and the resulting low true power factor may cause an increase in energy costs and may also cause equipment to wear out over time due to the low quality of power.

Harmonic distortion in power systems is typically abated and/or cancelled at the power source or at the connected load generally using active filter technologies. In cancelling the harmonic distortion, only a single benefit results—improved power quality. The improved power quality is expressed as more efficient operation of a connected load and more efficient power utilization.

Current practices, however, do not allow for the harvesting of the harmonic distortion (e.g., power source system and/or load harmonics) to act as a secondary power source for one or more connected loads. Such lacking results in substantial inefficient power utilization—i.e., with current practices the identified harmonic distortion is discarded or removed from a power system. By not harvesting and reusing the harmonic distortion, a power system is not capable of operating at its full efficiency.

Advantageously, it is beneficial to harvest the harmonic distortion (e.g., power system harmonics and/or load derived power harmonics) found in power applications and power source connected systems to act as a power source for connected loads (e.g., primary and/or secondary loads). As such, a two-fold benefit can result—firstly a reduction in the harmonic distortion being delivered to connected loads to a power source (e.g., a primary load, and/or secondary loads) which can result in prolonged operating life for the connected loads and secondly, substantial efficiency in the amount of overall power required to run the connected loads—e.g., in an illustrative configuration, the same amount of power that is typically used to provide power to run a single hundred watt (100 W) light bulb could be used to power the first 100 W light bulb, as well as an additional 100 W light bulb. Such systems and methods would directly impact power use optimization and utilization management.

From the foregoing it is appreciated that there exists a need for systems and methods to ameliorate the shortcomings of existing practices.

### SUMMARY

The herein described systems and methods described below are not limited to the particular systems, methodologies or protocols described, as these may vary. The terminology used in this document is for the purpose of describing particular embodiments only, and is not intended to limit the scope of the present disclosure.

As used in this document and in the appended claims, the singular forms “a,” “an,” and “the” include plural reference unless the context clearly dictates otherwise. Unless defined otherwise, all technical and scientific terms used in this document have the same meanings as commonly understood by one of ordinary skill in the art. As used in this document, the term “comprising” means “including, but not limited to.”

In an illustrative implementation, a system for harvesting and applying power harmonics comprises a shunt filter that is harmonically tuned for one or more connected loads primary source and is connected between a primary power source, a first load, and a secondary load. The shunt filter generally comprises at least one inductor connected serially to at least one capacitor. Operatively, the shunt filter separates harmonic current and the fundamental current from the root mean square current originating from a power source delivering the fundamental current to the first load. Illustratively, the harmonic current is directed to the secondary load to power the secondary load. The neutral current originating from the secondary load is then returned back to the power source.

In another illustrative implementation, a system for harvesting and applying power harmonics comprises a shunt filter that is harmonically tuned for a primary source and is connected to the power system's load. The shunt filter generally comprises at least one inductor connected serially to at least one capacitor. Operatively, the shunt filter separates harmonic current and the fundamental current from the root mean square current originating from a power source delivering the harmonic current to drive the power system's load.

Other features of the herein described systems and methods are further described below.

### BRIEF DESCRIPTION OF THE DRAWINGS

FIG. 1 illustrates an illustrative implementation of an exemplary shunt circuit for use in accordance with the herein described systems and methods;

FIG. 2 illustrates an illustrative implementation of an exemplary power harmonic harvesting and application system;

FIG. 3 illustrates the interaction of various components and the connectivity of components of an illustrative implementation of an exemplary power harvesting and application system; and

FIG. 4 illustrates an alternative implementation of an exemplary power harmonic harvesting and application system.

### DETAILED DESCRIPTION

In an illustrative implementation, an exemplary system is provided to capture harmonic currents that are produced at the non-linear load (i.e., computer power supplies, lighting ballasts, variable frequency drives, etc.) as well as imported system harmonics (i.e., from the power source). In an illustrative operation, the harmonic current (e.g., higher than fundamental current) can be used to power the connected loads and/or can be re-injected in to an exemplary power system to increase power system efficiency.

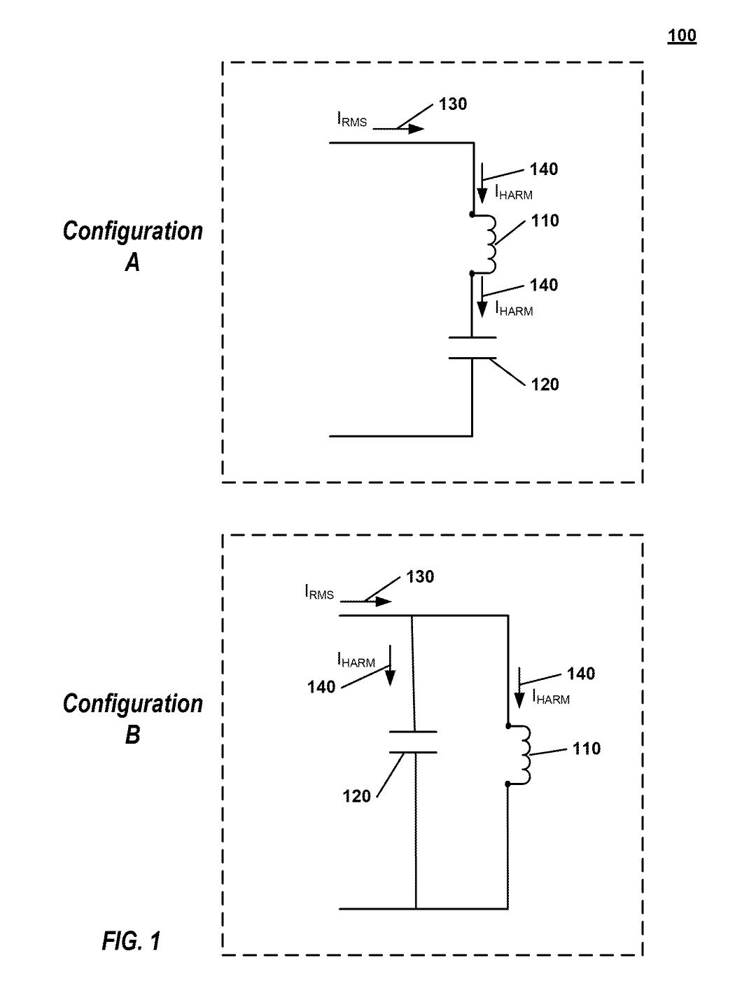

FIG. 1 shows an exemplary circuit that is used to capture power system and/or load harmonics. As is shown in FIG. 1, exemplary harmonic capture circuit 100 comprises inductor 110 electrically coupled to capacitor 120, which together are electrically connected to a power source that, illustratively operatively, is tuned to a selected harmonic resonant frequency. With previous practices, the harmonic currents in a power system are shunted to ground and therefore abated in the power system, not harvested and applied to the loads of a power system as practiced by the herein described systems and methods.

As is shown in FIG. 1, exemplary harmonic capture circuit 100 can be illustratively deployed in two configurations, Configuration A and Configuration B. It should be understood that the harmonic capture circuit 100 shown in FIG. 1, as well as the other harmonic capture circuits described in this application, are often referred to in the art as shunt filters and that these two terms are used interchangeably in the specification and claims. As is shown in Configuration A, inductor 110 is connected in series to capacitor 120 in the exemplary harmonic capture circuit 100. In Configuration B, inductor 110 is connected in parallel to capacitor 120 in exemplary harmonic capture circuit 100. One of ordinary skill in the art will appreciate that the configurations described in FIG. 1 are merely illustrative as the inventive concepts described herein apply to various circuits that can be tuned to a selected resonant frequency to operate in a manner as described herein.

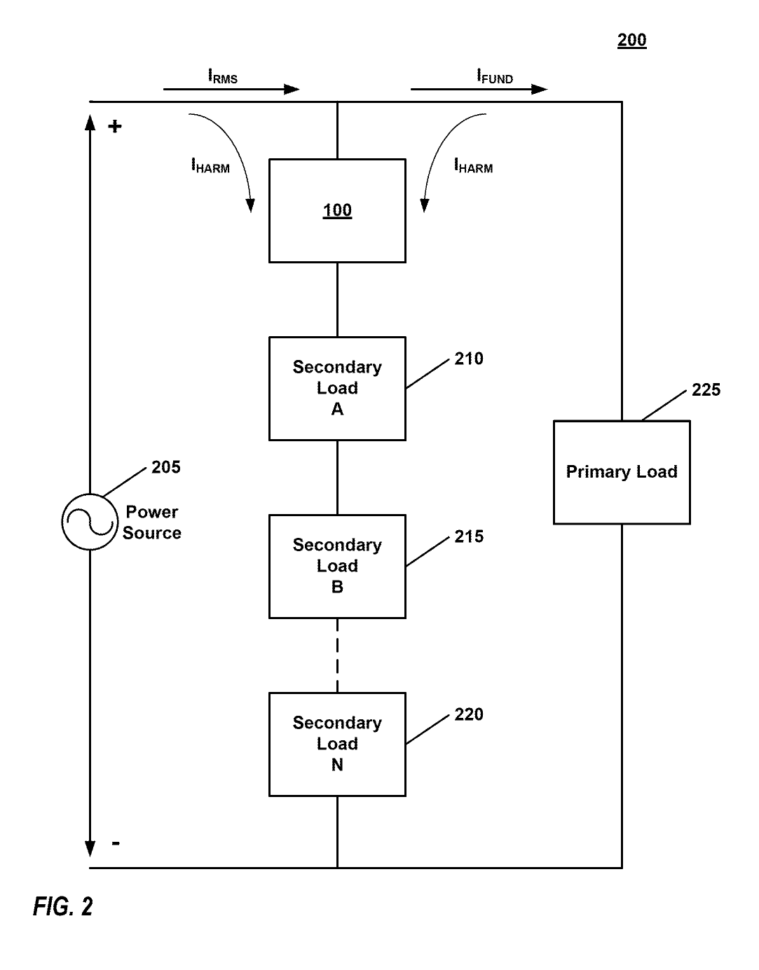

In an illustrative operation, as is shown in FIG. 1, the harmonic current (I_{HARM}) 140 is harvested from the root mean square current (I_{RMS}) 130 for application to a connected load (not shown). In an illustrative implementation, not shown in FIG. 1 but shown in FIGS. 2, 3, and 4, the harmonic current (I_{HARM}) can be then routed so that it drives power to various connected loads.

FIG. 2 shows an illustrative implementation of an exemplary configuration of cooperating components of exemplary power system 200 that practices harmonic power harvesting and application of harvested harmonics. As is shown, exemplary power system comprises power source 205, exemplary harmonic capture circuit 100 (of FIG. 1), primary load 225, and various secondary loads, i.e., secondary load A 210, secondary load B 215, up to and including secondary load N 220. In an illustrative implementation, power source 205 comprises one or more of a single phase or three phase type power supply having three or four wires.

The dotted connection line between secondary load B and secondary load N merely indicates that there could be numerous loads connected in series between secondary load B and secondary load N.

As is shown in FIG. 2, in an illustrative implementation, power source 205 is connected in parallel to the serial combination of harmonic capture circuit 100 and secondary loads, 210, 215, and 220, which combination is, in turn, connected in parallel to primary load 225. Further, as is shown in FIG. 2, the non-load connected leg of the last serially connected secondary load is electrically connected to the neutral side of power source 205.

In an illustrative operation, power source 205 generates root mean square current (I_{RMS}) which is broken down by harmonic capture circuit 100 to fundamental current (I_{FUND}) and harmonic current (I_{HARM}). As is shown, I_{HARM} is delivered to secondary loads 210, 215, and 220 to provide power to secondary loads 210, 215, and 220. In the illustrative operation, the separated I_{FUND} is then driven to primary load 225 to deliver power to primary load 225. Further, as is shown in FIG. 2, additional harmonic current I_{HARM} is imported from the power system (e.g., primary load 225) and directed to harmonic capture circuit 100 for delivery to secondary loads, 210, 215, and 220.

Although FIG. 2 shows an exemplary configuration of cooperating components of a harmonic harvesting enabled power system, it should be understood that such configuration is merely a description of one of many possible configurations. One skilled in the art will appreciate that the inventive concepts described herein can be applied to a harmonic harvesting enabled power system having various numbers and types of loads in various configurations and using various numbers and types of harmonic harvest capture circuits as well as various types of power sources.

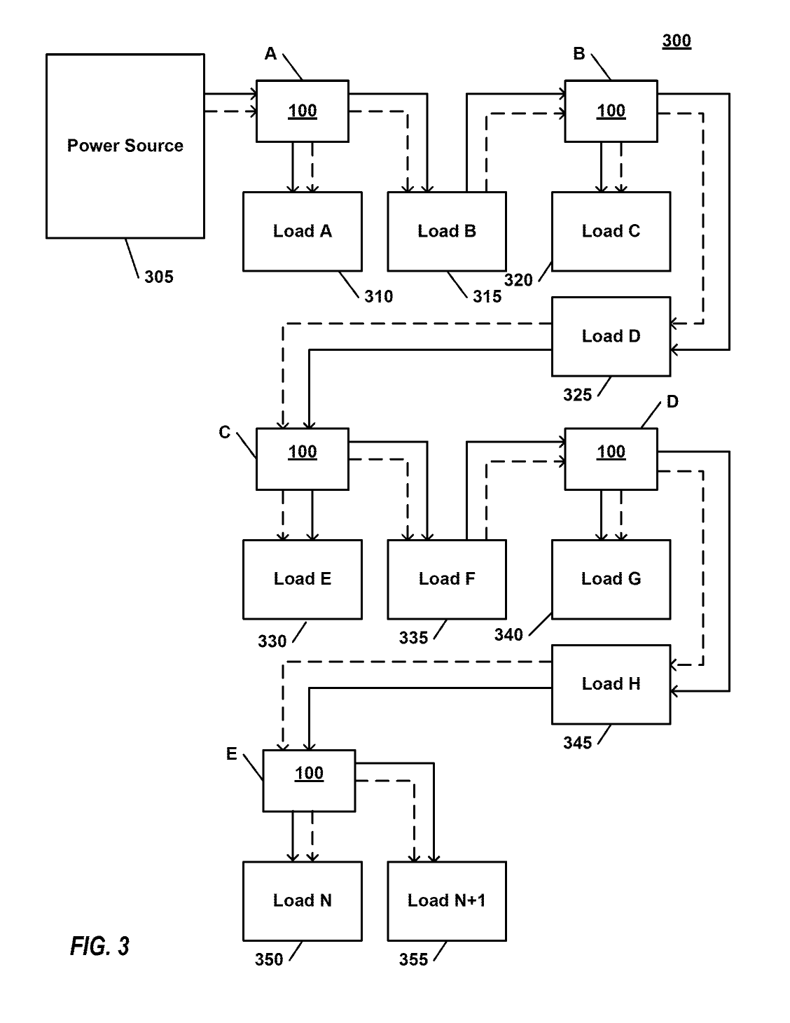

FIG. 3 shows an illustrative implementation of an exemplary power system 300 having multiple loads, and the interconnectivity of such loads. As is shown in FIG. 3, exemplary power system 300 comprises power source 305, various harmonic capture circuits 100 (A-E), load A 310, load B 315, load C 320, load D 325, load E 330, load F 335, load G 340, load H 345, up to and including load N 350 and load N+1 355. In an illustrative implementation, power source 305 comprises one or more of a single phase or three phase type power supply having three or four wires.

In an illustrative implementation, power source 305 is electrically connected to harmonic capture circuit 100 (A), which in turn is illustratively electrically connected to a load pair comprising load A 310 and load B 315, as is shown. Load B 315 is electrically connected to harmonic capture circuit 100 (B), which is electrically connected to a load pair comprising load C 320 and load D 325, as is shown. Load D 325 is electrically connected to harmonic capture circuit 100 (C), which is electrically connected to a load pair comprising load E 330 and load F 335, as is shown. Load F 335 is electrically connected to harmonic capture circuit 100 (D), which is electrically connected to a load pair comprising load G 340 and load H 345, as is shown. Load H is electrically connected to harmonic capture circuit 100 (E), which is electrically connected to up to and including a load pair comprising load N 350 and load N+1 355, as is shown. As is shown, there can be endless number of harmonic capture circuits 100 and load pairs, though these quantities may be generally limited by the amount of power that can be delivered by power source 305.

In an illustrative implementation, harmonic capture circuit 100 can comprise a single circuit that has federated circuits (not shown) and remotely located that are electronically connected as described in FIG. 3, or can comprise individual harmonic circuits individually connected and proximately located to the loads as described in FIG. 3.

In an illustrative implementation, exemplary power system 300 can be representative of a conventional lighting circuit found in conventional commercial building and or industrial buildings. In this illustrative implementation, with the use and selected deployment of five harmonic capture circuits 100 interconnected as described in FIG. 3, the same amount of power that would conventionally power only five (5) loads is optimized to power ten (10) loads through the use of captured harmonic currents (as described by FIGS. 2 and 3).

In an illustrative operation, power source 305 delivers I_{RMS} to each of the harmonic capture circuits 100 (A, B, C, D, and E) that is separated into I_{HARM}, which drives the secondary load of each of the load pairs (load A 310, load C 320, load E 330, load G 340, and up to and including load N 350), and I_{FUND}, which drives the primary loads (load B 315, load D 325, load F 335, load H 345, and up to and including load N+1 355) of each of the load pairs.

Although FIG. 3 shows an exemplary configuration of cooperating components of a harmonic harvesting enabled power system, it should be understood that such configuration is merely a description of one of many possible configurations. One skilled in the art will appreciate that the inventive concepts described herein can be applied to a harmonic harvesting enabled power system having various numbers and types of loads in various configurations and using various numbers and types of harmonic harvest capture circuits, as well as various types of power sources.

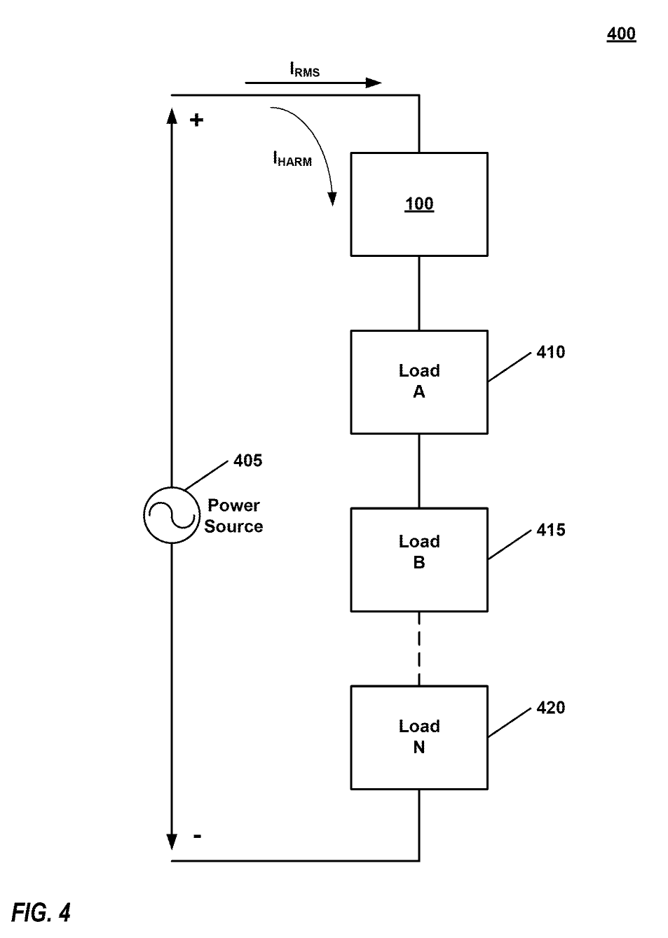

FIG. 4 shows an illustrative implementation of an exemplary configuration of cooperating components of exemplary power system 400 that practices harmonic power harvesting and application of harvested harmonics. As is shown, exemplary power system comprises power source 405, exemplary harmonic capture circuit 100 (of FIG. 1), and various loads, secondary load A 410, secondary load B 415, and up to and including secondary load N 420. The dotted connection line between secondary load B 415 and secondary load N 420 merely indicates that there could be numerous loads connected in series between secondary load B 415 and secondary load N 420. In an illustrative implementation, power source 405 comprises one or more of a single phase or three phase type power supply having three or four wires.

As is shown in FIG. 4, in an illustrative implementation, power source 405 is connected in parallel to the serial combination of harmonic capture circuit 100 and loads 410, 415, and 420. Further, as is shown in FIG. 4, the non-load connected leg of the last serially connected load is electrically connected to the neutral side of power source 405.

In an illustrative operation, power source 405 generates root mean square current (I_{RMS}) which is broken down by harmonic capture circuit 100 to capture the harmonic current (I_{HARM}) components of I_{RMS}. As is shown, I_{HARM} is delivered to loads 210, 215, and 220 to provide power to loads 210, 215, and 220.

Although FIG. 4 shows an exemplary configuration of cooperating components of a harmonic harvesting enabled power system, it should be understood that such configuration is merely a description of one of many possible configurations. One skilled in the art will appreciate that the inventive concepts described herein can be applied to a harmonic harvesting enabled power system having various numbers and types of loads in various configurations and using various numbers and types of harmonic harvest capture circuits well as various types of power sources.

While several illustrative implementations have been described in this document by way of example, those skilled in the art will appreciate that various modifications, alterations, and adaptations to the described embodiments may be realized without departing from the spirit and scope of the invention, as defined by the appended exemplary claims.

1. A system for harvesting and applying power harmonics as part of power management, comprising:
a power source;
a first load;
a second load; and
a shunt filter comprising at least one inductor and at least one capacitor to create a shunt filter circuit, the shunt filter being harmonically tuned to the power source, the shunt filter being electrically connected between the power source and the second load and electrically connected in series to the second load to create a shunt filter second load serial combination, the first load being electrically connected in parallel to the power source and being electrically connected in parallel to the shunt filter second load serial combination.

2. The system as recited in claim 1, wherein the second load comprises two or more serially connected loads.

3. The system as recited in claim 1, wherein a neutral side of the second load is connected to a neutral side of the power source.

4. The system as recited in claim 1, wherein a neutral side of the first load is connected to a neutral side of the power source.

5. The system as recited in claim 1, wherein the power source generates root mean square current (I_{RMS}) to the shunt filter.

6. The system as recited in claim 5, wherein the shunt filter separates the delivered root mean square current (I_{RMS}) into harmonic current (I_{HARM}) and fundamental current (I_{FUND}) components.

7. The system as recited in claim 6, wherein the harmonic current (I_{HARM}) is delivered by the shunt filter to the second load.

8. The system as recited in claim 1, wherein the power source comprises any of a single phase three wire power source, single phase four wire power source, three phase three wire power source, and three phase four wire power source.

9. The system as recited in claim 1, wherein the shunt filter comprises two or more shunt filter circuits.

10. A system for harvesting and applying power harmonics as part of power management, comprising:
a power source;
a load; and
a shunt filter comprising at least one inductor and at least one capacitor, the combination being harmonically tuned to the power source, the shunt filter being connected between the power source and the load and connected in series to the load to create a shunt filter load serial combination, the load being electrically connected to the power source.

11. The system as recited in claim 10, wherein the load comprises two or more serially connected loads.

12. The system as recited in claim 10, wherein a neutral side of the load is electrically connected to a neutral side of the power source.

13. The system as recited in claim 10, wherein the power source generates root mean square current (I_{RMS}) to the shunt filter.

14. The system as recited in claim 13, wherein the shunt filter separates the delivered root mean square current (I_{RMS}) into harmonic current (I_{HARM}) and fundamental current (I_{FUND}) components.

15. The system as recited in claim 14, wherein the root mean square current is delivered by the shunt filter to the load.

16. The system as recited in claim 10, wherein the power source comprises any of a single phase three wire power source, single phase four wire power source, three phase three wire power source, and three phase four wire power source.

17. The system as recited in claim 10, wherein the shunt filter comprises two or more shunt filter circuits.

18. The system as recited in claim 1, wherein root mean square current (I_{HARM}) is generated by the first load and captured by the shunt circuit for delivery to the secondary load.

19. A method for harvesting and applying power harmonics as part of power management, comprising:
tuning a shunt filter to a selected harmonic of a power source;
placing the shunt filter in series in between the power source and a first load; and
connecting a neutral side of the first load to a neutral side of the power source.

20. The method as recited in claim 19, further comprising placing a second load in parallel to the power source.
